(19) United States
(12) Patent Application Publication
(10) Pub. No.: US 2006/0076389 A1
(43) Pub. Date: Apr. 13, 2006

(54) Method and apparatus for controlling and monitoring a brazing process

(76) Inventors: Alfred Kemper, Warstein (DE); Thomas Licht, Warstein (DE); Christian Robohm, Lippstadt (DE); Guido Strotmann, Anrochte (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/237,404

(22) Filed: Sep. 27, 2005

(30) Foreign Application Priority Data
Sep. 29, 2004 (DE) 102004047359.5-24

(51) Int. Cl. B23K 31/12

(52) U.S. Cl. 228/103

(57) ABSTRACT

In a method and a corresponding apparatus for controlling and monitoring the vacuum brazing of power components and SMD components, in which the temperature of the process is controlled using an open thermocouple, which is arranged separate from the furnace heating and is integrated in a base plate serving as a heat buffer, the temperature of the process is monitored and measured directly at the point of contact between brazing material and component. The uniformity of the temperature distribution during the process is measured by means of a contactless optical measuring system.

### CROSS-REFERENCE TO RELATED APPLICATIONS

This application claims priority from German Patent Application No. 10 2004 047 359.5-24, which was filed on Sep. 29, 2004, and is incorporated herein by reference in its entirety.

### TECHNICAL FIELD

The present invention relates to a method and an apparatus for controlling and monitoring a brazing process for vacuum-brazing of power components and SMD components, in which the temperature of the process is controlled using one or more open thermocouples arranged separate from the furnace heating and is monitored and measured directly at the point of contact between brazing material and component.

### BACKGROUND

SMD components are electronic components which do not have connecting wires, but rather are placed directly on the surface of an electronic printed circuit board and are contact-connected there in the brazing bath. Electronic components are often sensitive to absorbed moisture, which can lead to flaking and cracks in the interior of the components, to damage to connections and coatings and, in the worst-case scenario, to a crack in the component itself. SMD components, which are exposed to relatively high temperatures during the brazing process, are particularly susceptible to this type of damage, since the vapor pressure of the moisture in the interior of a component rises very considerably as soon as the component is exposed to higher temperatures.

On account of this problem, IPC/JEDEC standards (IPC/JEDEC J-STD-020B) have been introduced, defining the different demands imposed with regard to temperatures, temperature profiles and holding times as a function of the type of SMD component, its thickness and its volume. Compliance with the temperature profile stipulated in the standard is supposed to ensure defect-free reflow soldering of the component in question. It is therefore necessary for the temperature profile, the level and time above the liquidus temperature, the uniformity of the temperature distribution and the observation of heating and cooling ramps to be accurately monitored during the soldering operation.

Soldering processes which are typically used nowadays include wave soldering, reflow soldering and vapor phase soldering. The drawback of wave soldering and vapor phase soldering resides in the very steep heat-up flank, which on account of the process properties cannot be set or can only be set with considerable difficulty. In the case of reflow soldering, the question also arises after the heating or cooling ramp has been established. Moreover, if large-area power semiconductors are being used, it is necessary to work in evacuated process areas in order to minimize the vapor pressure and therefore to reduce the risk of damage and to avoid the formation of voids in the solder.

For example, DE 29 08 829 C3 describes a method for carrying out a brazing operation in a vacuum chamber, in which components which are to be joined to one another are joined to one another by melting a brazing alloy at approx. 600° C. The cooling then takes place outside the process chamber in normal ambient atmosphere. The method. has the drawback that the cooling no longer takes place in a defined process atmosphere, which can lead to defects in the component.

DE 199 53 654 A1 describes a method for the heat treatment of workpieces or components, in particular for producing solder joins, in which the component is first of all heated in a reflow chamber in an atmosphere closed off from the surrounding environment, and then in a subsequent method step in a cooling chamber, the cooling of the component likewise takes place in a closed process atmosphere. Reflow chamber and cooling chamber in this case form process spaces which are independent of one another. It is possible to produce a vacuum in the respective process spaces. In this method, the temperature is managed by means of a temperature-control device, which is preferably operated as a radiant device, with the temperature of the component being set by means of the distance between the radiant device and the component or the solder material. A further advantageous embodiment provides for a combination of a radiant device with a contact device, so that direct temperature transfer is possible at least in the initial phase of heating and cooling, and temperature is applied by means of conduction of heat or refrigeration, allowing the heating and cooling times to be considerably shortened. An advantageous embodiment consists in designing the radiant device as a plate whereof the temperature can be controlled and the surface of which can then serve as a contact device. The distance between the radiant device and the component is controlled by means of a temperature sensor, which is arranged either in the solder material carrier itself or directly at the radiant device. In the second case, the contact with the carrier device is ensured by means of a connecting device, such as for example a spring device.

Although the method outlined above and the corresponding apparatus provide significantly better control of the heating and cooling ramp of the soldering profile than previously known methods, direct monitoring of the temperature during the brazing operation is still not possible, which means that the setting of the heating and cooling ramp, but also the measurement of the maximum temperature (peak temperature) and the determination of the level and time above the liquidus temperature, are critical. Furthermore, in the known methods, as before, the uniformity of the temperature distribution, in particular in the peak range, remains a problem.

### SUMMARY

Therefore, the object of the present invention is to provide a method and an apparatus in which the abovementioned problems are solved and accurate measurement of the maximum temperature, control of the level and duration of action of the temperature above the liquidus temperature, exact setting of the temperature profile (heating and cooling ramps) and the uniformity of the temperature distribution are ensured.

This object can be achieved by a method for controlling and monitoring a brazing process for the vacuum-brazing of power components and SMD components, the method comprising the step of controlling the temperature of the process by using an open thermocouple, which is arranged separate from the furnace heating, and is monitored and measured directly at the point of contact between brazing material and component.

The brazing process can be carried out in one step. The thermocouple can be integrated in a base plate which is simultaneously used as a heat buffer and the heat capacity and thermal resistance of which can be used to influence and optimize the heating ramp of the brazing process. Copper, aluminum, molybdenum and/or metal-matrix composites can be used as material for the base plate. An additional layer can be applied to the base plate or integrated in the base plate, in order to improve the distribution of heat. The additional layer may consist of pyrolitic graphite or diamond. The furnace heating may comprise a heating plate. The heating plate can be composed of segments. An additional layer can be applied to the heating plate or integrated in the heating plate in order to improve the distribution of heat. The additional layer may consist of pyrolitic graphite or diamond. The uniformity of the temperature profile on the brazing material can be monitored by means of a contactless optical measuring system. A pyrometer, an IR measuring cell or a fiber-optic element can be used as the contactless optical measuring system.

The object can also be achieved by an apparatus for carrying out a method for controlling and monitoring a brazing process for the vacuum-brazing of power components and SMD components, comprising a vacuum chamber, the temperature of which is controlled by means of a furnace heating, wherein the temperature measurement is controlled by way of an open thermocouple which is arranged separate from the furnace heating in the vacuum chamber and is integrated. in a base plate, the base plate being directly connected to the substrate for the components.

The temperature distribution on the brazing material can be measured by means of a contactless optical measuring system. Copper, aluminum, molybdenum and/or metal-matrix composites may be used as material for the base plate. An additional layer can be applied to the base plate or integrated in the base plate, in order to improve the distribution of heat. The additional layer may consist of pyrolitic graphite or diamond. The furnace heating may comprise a heating plate. The heating plate can be composed of segments. An additional layer can be applied to the heating plate or integrated in the heating plate in order to improve the distribution of heat. The additional layer may consist of pyrolitic graphite or diamond. A pyrometer, an IR measuring cell or a fiber-optic element can be used as the contactless optical measuring system.

### BRIEF DESCRIPTION OF THE DRAWINGS

The invention is explained in more detail below on the basis of the exemplary embodiments illustrated in the figures of the drawing, in which:

FIG. 1 shows a diagrammatic illustration of the vacuum chamber in which the method is carried out,

FIG. 2 shows a comparison of the heat-up properties of the brazing material in different soldering processes.

### DETAILED DESCRIPTION

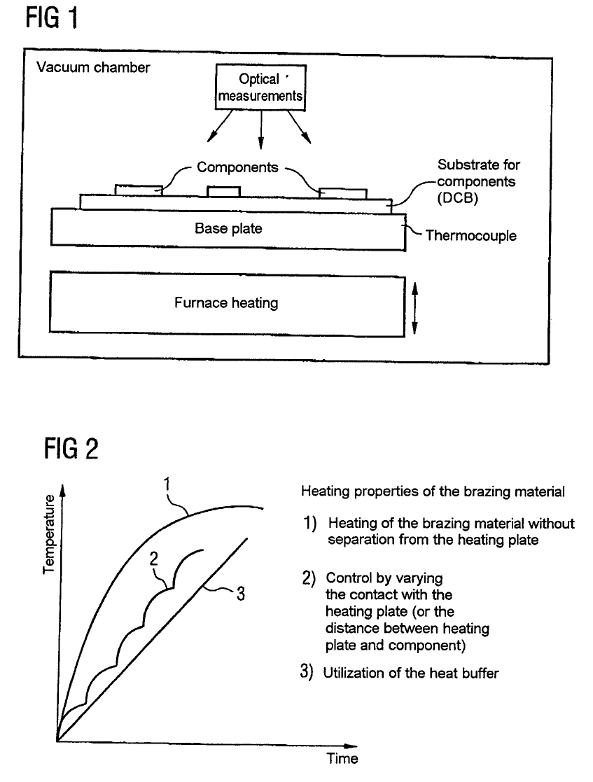

As shown in FIG. 1, the process is carried out in a vacuum chamber, with the setting and maintaining of at least one temperature profile being controlled by means of at least one open thermocouple 8, which is arranged separate from the furnace heating 9. This ensures that the temperature recording takes place directly in the region of the components 5 arranged on a substrate 6 (e.g. DCB), with the result that improved control of the temperature and temperature profile is possible. This is particularly important for accurate determination of the peak temperature and the control of the heat treatment time above the liquidus temperature. The thermocouple 8 is integrated in a base plate 7 which serves as a heat buffer and the heat capacity and thermal resistance of which are used to influence and optimize the heating and cooling ramps.

The advantage of the method according to the invention over the conventional soldering processes is illustrated in FIG. 2, which shows a comparison of the heating properties of the soldering material for the various soldering processes. It can be seen from this figure that the use of a heat buffer in accordance with the present invention allows exactly linear and direct control of the brazing process, whereas the conventional processes, which involve heating up the soldering material without separation from the heating plate or control by varying the contact with the heating plate (varying the distance between the heating and the soldering material) with simultaneous separation of heating plate and soldering material, have nonlinear heating curves, making it more difficult to comply with the temperature profile stipulated in the JEDEC standard.

In the method according to the invention, metallic copper is usually used as material for the base plate 7, the thickness of the plate being between approximately 1 and 10 mm. As an alternative to copper, depending on the process requirements, it is also possible for other metals or metal composites to be used as materials for the base plate 7. Aluminum and molybdenum may be mentioned as advantageous exemplary embodiments of other metals. By exchanging the plate material, it is possible to adjust the thermal resistance and heat capacity between brazing material and heating plate or base plate and heating plate in accordance with the process requirements. A further possible way of adjusting the thermal resistance and the heat capacity between base plate and heating plate consists in varying the gas medium in the vacuum chamber 4, for example by altering the pressure and composition.

As can also be seen from the illustration in FIG. 1, the uniformity of the temperature distribution on the brazing material is measured by means of a contactless optical measuring system 10, in which case the optical measuring system 10 used may advantageously be a pyrometer, an IR measuring cell or a fiber-optic element. The evaluation of the measurement can then be used to provide feedback to the furnace control and therefore process control

In an advantageous embodiment of the present invention, the uniformity of the temperature distribution can additionally be improved by segmenting the heating plate in combination with the recording of the temperature on the brazing material surface with simultaneous feedback to the heating controller system. In this case, it is possible to use the thermography image to control the individual segments and thereby to achieve active dynamic heating control. It is in this way possible to compensate for differences in the different regions of the component caused by differences in mass, unevenness, curvature or similar effects.

In further advantageous embodiments, an additional layer, for example pyrolitic graphite or diamond, can be applied to or integrated in the heating plate and/or the base plate, in order to improve the distribution of heat and thereby to further optimize the temperature management.

List of Designations:

1 Heating step
2 Control step
3 Utilization of the heat buffer
4 Vacuum chamber
5 Components
6 Substrate for components
7 Base plate
8 Thermocouple
9 Heating
10 Optical measurement system

What is claimed is:

1. A method for controlling and monitoring a brazing process for the vacuum-brazing of power components and SMD components, the method comprising the step of controlling the temperature of the process by using an open thermocouple, which is arranged separate from the furnace heating, and is monitored and measured directly at the point of contact between brazing material and component.

2. A method according to claim 1, wherein the brazing process is carried out in one step.

3. A method according to claim 1, wherein the thermocouple is integrated in a base plate which is simultaneously used as a heat buffer and the heat capacity and thermal resistance of which can be used to influence and optimize the heating ramp of the brazing process.

4. A method according to claim 3, wherein copper, aluminum, molybdenum and/or metal-matrix composites are used as material for the base plate.

5. A method according to claim 3, wherein an additional layer is applied to the base plate or integrated in the base plate, in order to improve the distribution of heat.

6. A method according to claim 5, wherein the additional layer consists of pyrolitic graphite or diamond.

7. A method according to claim 1, wherein the furnace heating comprises a heating plate.

8. A method according to claim 7, wherein the heating plate is composed of segments.

9. A method according to claim 7, wherein an additional layer is applied to the heating plate or integrated in the heating plate in order to improve the distribution of heat.

10. A method according to claim 9, wherein the additional layer consists of pyrolitic graphite or diamond.

11. A method according to claim 1, wherein the uniformity of the temperature profile on the brazing material is monitored by means of a contactless optical measuring system.

12. A method according to claim 11, wherein a pyrometer, an IR measuring cell or a fiber-optic element is used as the contactless optical measuring system.

13. An apparatus for carrying out a method for controlling and monitoring a brazing process for the vacuum-brazing of power components and SMD components, comprising a vacuum chamber, the temperature of which is controlled by means of a furnace heating, wherein the temperature measurement is controlled by way of an open thermocouple which is arranged separate from the furnace heating in the vacuum chamber and is integrated in a base plate, the base plate being directly connected to the substrate for the components.

14. An apparatus according to claim 13, wherein the temperature distribution on the brazing material is measured by means of a contactless optical measuring system.

15. An apparatus according to claim 13, wherein copper, aluminum, molybdenum and/or metal-matrix composites are used as material for the base plate.

16. An apparatus according to claim 13, wherein an additional layer is applied to the base plate or integrated in the base plate, in order to improve the distribution of heat.

17. An apparatus according to claim 16, wherein the additional layer consists of pyrolitic graphite or diamond.

18. An apparatus according to claim 13, wherein the furnace heating comprises a heating plate.

19. An apparatus according to claim 18, wherein the heating plate is composed of segments.

20. An apparatus according to claim 18, wherein an additional layer is applied to the heating plate or integrated in the heating plate in order to improve the distribution of heat.

21. An apparatus according to claim 20, wherein the additional layer consists of pyrolitic graphite or diamond.

22. An apparatus according to claim 13, wherein a pyrometer, an IR measuring cell or a fiber-optic element is used as the contactless optical measuring system.
